(19) United States
(12) Patent Application Publication
(10) Pub. No.: US 2017/0030782 A1
(43) Pub. Date: Feb. 2, 2017

(54) MULTI-POINT TEMPERATURE COMPONENT HEATING TESTING METHOD

(71) Applicant: FEI-CHE HUNG, Taoyuan City (TW)

(72) Inventor: FEI-CHE HUNG, Taoyuan City (TW)

(21) Appl. No.: 14/809,554

(22) Filed: Jul. 27, 2015

(51) Int. Cl. G01K 15/00

(52) U.S. Cl. CPC G01K 15/007

(57) ABSTRACT

A multi-point temperature heating testing method comprises steps: providing a standard temperature unit and several tested temperature units, electrically connecting the testing device to the standard temperature unit and the several tested temperature units, creating data in the testing device, then the testing device performs computing on the created data and saving the data after computing, putting the standard temperature unit and the several tested temperature unit into the heater, transferring the actual temperature measured by the standard temperature unit and the testing temperature measured by the tested temperature units to the testing device for performing an error percentage analysis, if the error percentage is within the setup range, the determination result is qualified, if not, the determination result is not qualified, recording the data and generating calibration curve for generating a report, determining if temperature sensing components installed in the heater operates normal according to analysis data.

### BACKGROUND OF THE INVENTION

Field of the Invention

The prevention relates to a heating calibration method, in particular the method relates to a method for testing if the temperature sensing components installed in the heater operates normally or is damaged.

Description of Prior Art

Traditionally, a temperature sensing component is installed inside the heater for sensing if the heating temperature of the heater is heated up to the required temperature. After the heater is used for a period of time, the temperature sensing component is aged or damaged, which causes imprecise measurement for the heating temperature of the heater. Accordingly, it is required to test the temperature sensing component and determine if the sensing component fails.

The heater uses different heating temperatures based on purposes using the heater. Therefore, the testing organization has to prepare heaters for different temperatures during testing. Also, it is required to detach the temperature sensing component to put it in different heater for performing heating testing. As a result, the testing equipment investment is too high, and the testing process requires longer working hours as well as more procedures.

### SUMMARY OF THE INVENTION

Therefore, the present invention provide a standard temperature unit and several tested temperature units which are arranged at a specific distance, and are put in a heater (or a thermostatic oven), for performing temperature sensing test under different temperatures. The method reduces the testing equipment cost, simplifies the testing process, and reduces required testing working hours and process. In addition, the standard temperature unit and the several tested temperature units can perform self-test in order to determine if the testing is correct.

In order to achieve the above objectives, the present invention provides a multi-point temperature heating testing method, used for testing if the temperature sensing components installed inside the heater operates normal. The method comprises: providing a standard temperature unit and several tested temperature units, providing a testing device, and the testing device creating data after the testing device electrically connected to the standard temperature unit and the tested temperature unit, the testing device performing computing on the created data after the data is created, saving the computed data after the computing is completed, putting the standard temperature unit and the tested temperature unit in the heater, heater starting heating after the standard temperature unit and the tested temperature unit put in the heater, lastly transferring an actual temperature measured by the standard temperature unit and a testing temperature measured by the tested temperature unit to the testing device during heating process, the testing device performing an error percentage analysis on the actual temperature and the testing temperature, if the error percentage data is within the tolerance range, the determination result is qualified, if the error percentage is not within the tolerance range, the determination result is not qualified, and using the analysis data for determining if the sensing component installed in the heater operates normal according to the analysis data.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a schematic flowchart of a multi-point temperature heating testing method according to the present invention;

FIG. 2 is an arrangement schematic diagram of the standard temperature units and the several tested temperature unit according to the present invention;

FIG. 3 is a configuration connection schematic diagram of the testing device, the standard temperature unit, the tested temperature unit and the heater according to the present invention;

FIG. 4 is a created data screen schematic diagram according to the present invention;

FIG. 5 is a calibration curve schematic diagram according to the present invention; and

FIG. 6 is a testing/calibration table of temperature components according to the present invention.

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

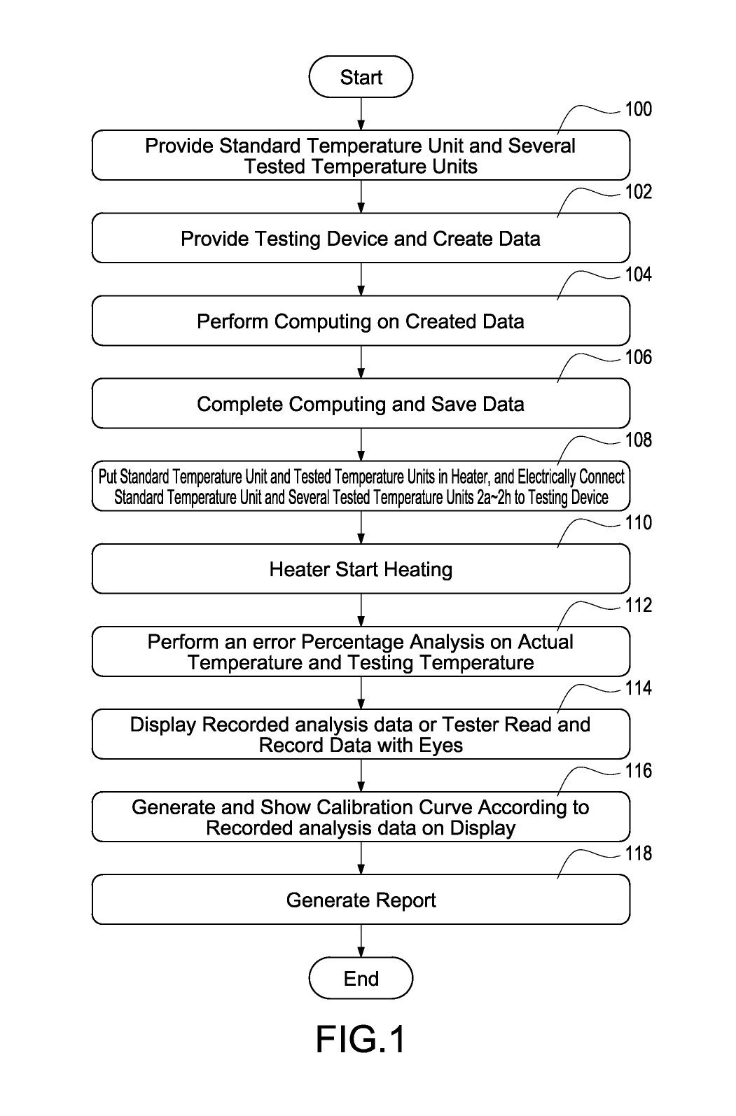

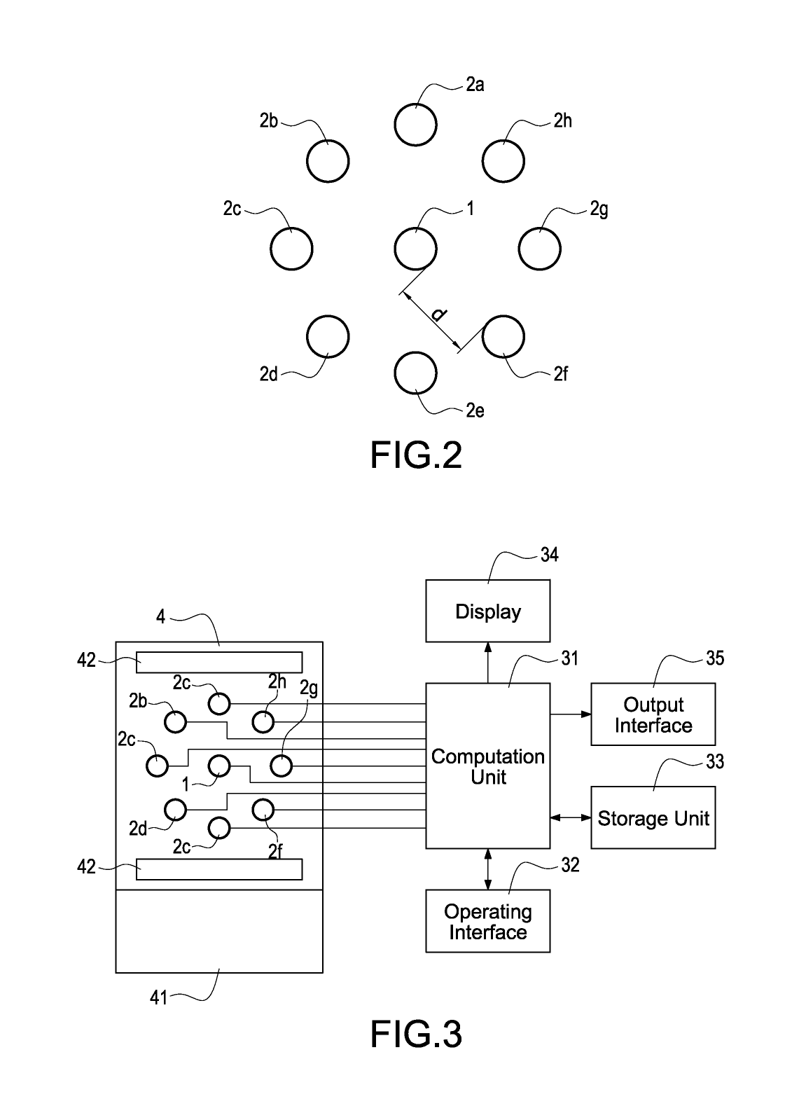

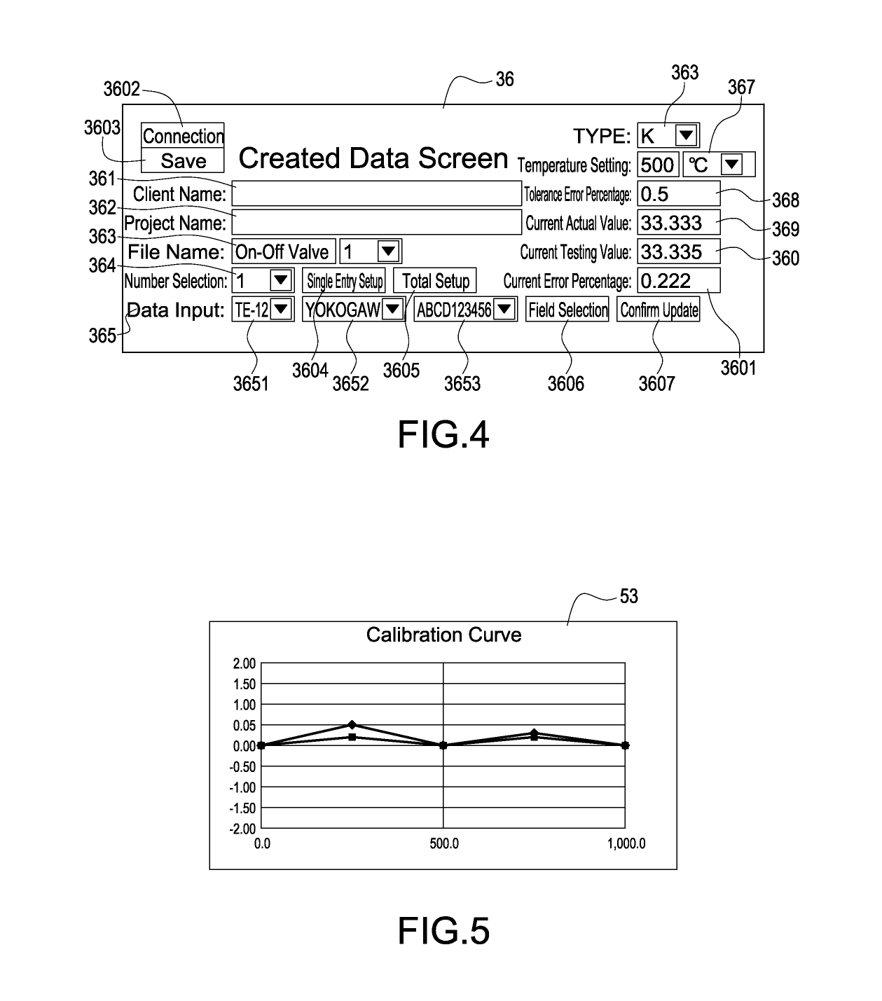

FIG. 1 and FIG. 2 are diagrams illustrating a multi-point temperature heating testing method according to the present invention. Firstly, in step 100, it provides a standard temperature unit 1 and several tested temperature units 2a˜2h. The standard temperature unit 1 is arranged to be in the center, the tested temperature units 2a˜2h are disposed around the standard temperature unit 1, the tested temperature units 2a˜2h and the standard temperature unit 1 are disposed at a specific distance d, and the specific distance is 5 cm in order to avoid the temperature interference among the tested temperature units 2a˜2h. In addition, the standard temperature unit 1 is certified by international certification organization. In the diagram, the standard temperature unit 1 and the tested temperature units 2a˜2h are strip shaped or an irregular shaped sensing temperature components.

In step 102, it provides a testing device, when create data, a display of the testing device (not shown in the diagram) displays the created data screen, fields in the created data screen comprise a client name field, a project field, a file name field, a number selection field, a data input field, a type field, a temperature setting field, a tolerance error percentage field, a current actual value (room temperature) field, a current testing value field, a current error percentage value field, a connection button, a save button, a single entry setup button, a total setup button, a field selection button and a confirm update button. The above-mentioned data input field further comprises a number field, a brand field and a serial number field. When presses the single entry setup button after the data is created, a number, a brand, and a serial number are displayed in a single field row; and when performs the testing, an actual temperature, a testing temperature, an error percentage and a determination result are displayed in a single field row. When presses the total setup button after the data is created, a number, a brand, and a serial number are displayed in a single field row; and when performs the testing, an actual temperature, a testing temperature, an error percentage and a determination result are displayed in a single field row. In addition, the measuring temperature range comprises options of the room temperature, 25%, 50%, 75% and 100%. For example, the room temperature is the actual measured temperature of the heater when the temperature is set at 500° C.; the measured temperature is 125° C. when the temperature is set at 25%; the measured temperature is 250° C. when the temperature is set at 50%; the measured temperature is 375° C. when the temperature is set at 75%; the measured temperature is 500 t when the temperature is set at 100%.

In step 104, it performs computing on the created data, after the data is created, the computation unit of the testing device starts computing according to the input data. The computation unit is a microprocessor.

In step 106, after the computation unit completes computing, the computed data is saved in a storage unit. The storage unit is a memory.

In step 108, it puts the standard temperature unit 1 and the tested temperature units 2a˜2h in the heater (not shown in the diagram), and electrically connect the standard temperature unit 1 and the several tested temperature units 2a˜2h to the testing device.

In step 110, the heater starts heating after the standard temperature unit 1 and the tested temperature units 2a˜2h are put in the heater.

In step 112, it transfers the actual temperature measured by the standard temperature unit 1 and the testing temperature measured by the tested temperature units 2a˜2h to the testing device during heating process, and the testing device performs an error percentage analysis on the actual temperature and the testing temperature, if the error percentage value (%) is determined within the setup range, “qualified” is recorded in the determination result field, and if the error percentage value (%) is determined not within the setup range, “not qualified” is recorded in the determination result field.

In step 114, the testing device records the data, and displays a status of qualify or not qualify on the display of the testing device after the determination analysis is completed.

In step 116, a calibration curve is generated according to the recorded analysis data, and the calibration curve is shown on the display.

In step 118, it generates a report, and transfer the recorded data and the calibration curve to printers to print out the recorded analysis data and the calibration curve.

In addition, a self-test can be performed on standard temperature unit 1 and the tested temperature units 2a˜2h. When the temperature data measured by the standard temperature unit 1 and the temperature data measured by the tested temperature units 2a˜2h are not within the setup range, it refers to that the standard temperature unit 1 is failed or damaged. For example, when the temperature data measured by the standard temperature unit is 100° C., and the temperature data measured by the tested temperature units 2a˜2h is 50° C., it refers to that the standard temperature unit 1 is failed or damaged.

Refer to FIG. 3, the testing device 3 comprises: a computation unit 31, an operating interface 32, a storage unit 33, a display 34 and an output interface 35.

The computation unit 31 electrically connects to the standard temperature unit 1 and the tested temperature units 2a˜2h, and is used for performing computing on the created data and the actual temperature and the testing temperature measured by the standard temperature unit 1 and the tested temperature units 2a˜2h, performing an analysis on the error percentage value of the actual temperature and the testing temperature, determining if the temperature component is qualified or not qualified according to error percentage value, recording the analysis data, generating a calibration curve according to the recorded analysis data, and generating a calibration curve according to the recorded analysis data for generating a report.

The operating interface 32 is composed of a plurality of buttons, electrically connects to the computation unit 31, and is used for inputting the data of the tested temperature units 2a˜2h with the plurality of buttons, where the data of the tested temperature units 2a˜2h is transferred to the computation unit 31 for performing computing.

The storage unit 33 electrically connects to the computation unit 31 and is used for saving the recorded analysis data generated after the computation unit 31 performs computing. The storage unit 33 is a memory.

The display 34 electrically connects to the computation unit 31, and is used for displaying the created data screen, the data calibration table and the calibration curve.

The output interface 35 electrically connects to the computation unit 31. The output interface 35 also electrically connects to external printers (not shown in the diagram) for transferring the recorded analysis data result of qualified or not qualified and the calibration curve generated by the computation unit 31 to the printers to print out the analysis data and the curve for generating a report. The output interface is a connector (USB) or a wireless transmission module.

Refer to FIG. 3˜FIG. 5, when the heater 4 performs measurement, the standard temperature unit 1 and the tested temperature units 2a˜2h are first put inside the heater 4, and the standard temperature unit 1 and the tested temperature units 2a˜2h electrically connect to the computation unit 31 of the testing device 3. During the measurement, the display 34 of the testing device 3 displays a created data screen 36. The fields on the created data screen 36 comprises a client name field 361, a project name field 362, a file name field 363, a number selection field 364, a data input field 365, a type field 366, a temperature setting field 367, a tolerance error percentage field 368, a current actual value (room temperature) field 369, a current testing value field 360, a current error percentage field 3601, a connection button 3602, a save button 3603, a single entry setup button 3604, a total setup button 3605, a field selection button 3606 and a confirm update button 3607. The data input field 365 further comprises a number field 3651, a brand field 3652 and a serial number field 3653. A data calibration table (as shown in the below table) is provided under the created data, the created data and the measured data analysis are automatically recorded in the data calibration table (the data calibration table is shown in a single field row).

After the data is created, the room temperature measured by the standard temperature unit 1 is 33.333° C., and the testing temperature measured by the tested temperature unit 2a is 33.335° C. After the testing device 3 performs computing, the error percentage value generated is 0.002. The 25% temperature range is measured after the room temperature is measured. The temperature controller 41 of the heater 4 triggers the heater 42 to heating the heater 42 up to 125° C. The room temperature measured by the standard temperature unit 1 is 249.333° C. and the testing temperature measured by the tested temperature unit 2a is 249.335° C. After the testing device 3 performs computing, the error percentage value generated is 0.002. Accordingly, after perform measurement under different temperatures and determine the error percentage is within the setup range, the determination result is qualified, and the determination result is displayed in the determination result field. If the error percentage is not within the setup range, the determination result is not qualified, and the determination result is displayed in the determination result field. After complete measurement, the testing device 1 generates a calibration curve according to the recorded data.

Data calibration table:

| | | | | room | | | | | determination |
|---|---|---|---|---|---|---|---|---|---|
| selection | components | | Percentage (%) | temperature | 25% | 50% | 75% | 100% | result |
| 1 | number | TE-1234567890 | actual | 33.333 | 124.333 | 249.333 | 374.333 | 499.333 | qualify |
| | | | temperature | | | | | | |
| | brand | YOKOGAWA | testing | 33.335 | 124.335 | 249.335 | 374.335 | 499.335 | |
| | | | temperature | | | | | | |
| | serial | ABCD12345678 | Error | 0.002 | 0.002 | 0.002 | 0.002 | 0.002 | |
| | number | | percentage (%) | | | | | | |
| 2 | number | TE-1234567890 | actual | 000.000 | 000.000 | 000.000 | 000.000 | 000.000 | |
| | | | temperature | | | | | | |
| | brand | YOKOGAWA | testing | 000.000 | 000.000 | 000.000 | 000.000 | 000.000 | |
| | | | temperature | | | | | | |
| | serial | ABCD12345678 | Error | 000.000 | 000.000 | 000.000 | 000.000 | 000.000 | |
| | number | | percentage (%) | | | | | | |
| 3 | number | TE-1234567890 | actual | 000.000 | 000.000 | 000.000 | 000.000 | 000.000 | |
| | | | temperature | | | | | | |
| | brand | YOKOGAWA | testing | 000.000 | 000.000 | 000.000 | 000.000 | 000.000 | |
| | | | temperature | | | | | | |
| | serial | ABCD12345678 | Error | 000.000 | 000.000 | 000.000 | 000.000 | 000.000 | |
| | number | | percentage (%) | | | | | | |
| 4 | number | TE-1234567890 | actual | 000.000 | 000.000 | 000.000 | 000.000 | 000.000 | |
| | | | temperature | | | | | | |
| | brand | YOKOGAWA | testing | 000.000 | 000.000 | 000.000 | 000.000 | 000.000 | |
| | | | temperature | | | | | | |
| | serial | ABCD12345678 | Error | 000.000 | 000.000 | 000.000 | 000.000 | 000.000 | |
| | number | | percentage (%) | | | | | | |
| 5 | number | TE-1234567890 | actual | 000.000 | 000.000 | 000.000 | 000.000 | 000.000 | |
| | | | temperature | | | | | | |
| | brand | YOKOGAWA | testing | 000.000 | 000.000 | 000.000 | 000.000 | 000.000 | |
| | | | temperature | | | | | | |
| | serial | ABCD12345678 | Error | 000.000 | 000.000 | 000.000 | 000.000 | 000.000 | |
| | number | | percentage (%) | | | | | | |
| 6 | number | TE-1234567890 | actual | 000.000 | 000.000 | 000.000 | 000.000 | 000.000 | |
| | | | temperature | | | | | | |
| | brand | YOKOGAWA | testing | 000.000 | 000.000 | 000.000 | 000.000 | 000.000 | |
| | | | temperature | | | | | | |
| | serial | ABCD12345678 | Error | 000.000 | 000.000 | 000.000 | 000.000 | 000.000 | |
| | number | | percentage (%) | | | | | | |
| 7 | number | TE-1234567890 | actual | 000.000 | 000.000 | 000.000 | 000.000 | 000.000 | |
| | | | temperature | | | | | | |
| | brand | YOKOGAWA | testing | 000.000 | 000.000 | 000.000 | 000.000 | 000.000 | |
| | | | temperature | | | | | | |
| | serial | ABCD12345678 | Error | 000.000 | 000.000 | 000.000 | 000.000 | 000.000 | |
| | number | | percentage (%) | | | | | | |
| 8 | number | TE-1234567890 | actual | 000.000 | 000.000 | 000.000 | 000.000 | 000.000 | |
| | | | temperature | | | | | | |
| | brand | YOKOGAWA | testing | 000.000 | 000.000 | 000.000 | 000.000 | 000.000 | |
| | | | temperature | | | | | | |
| | serial | ABCD12345678 | Error | 000.000 | 000.000 | 000.000 | 000.000 | 000.000 | |
| | number | | percentage (%) | | | | | | |

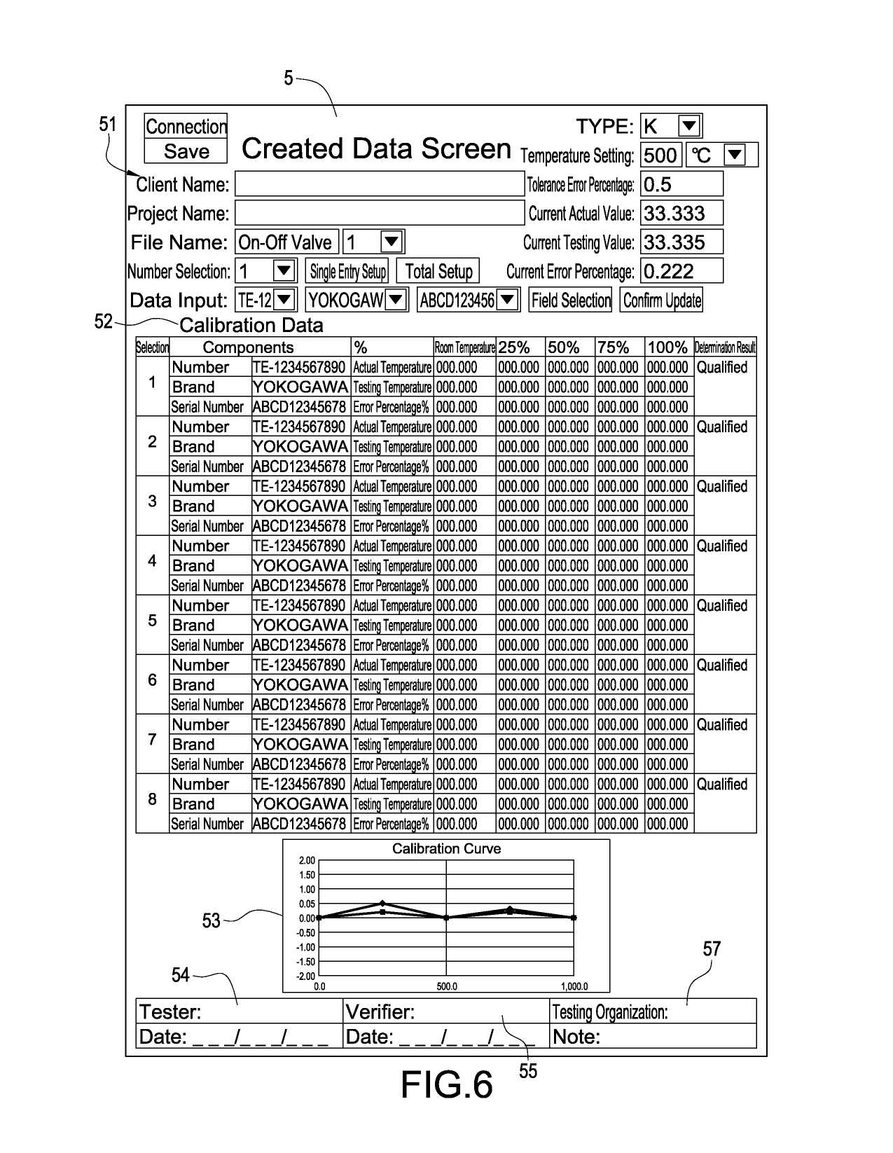

FIG. 6 is a testing/calibration table of temperature components according to the present invention. As shown in the diagram, after the heater testing is completed, the tester or the delegator may transfer the data to printers to print out the temperature component testing/calibration table for generating a report 5. In the diagram, the content of the temperature component testing/calibration table comprises at least the created data 51, the calibration data 52, a calibration curve 53, a tester 54, a verifier 55, a date 56 and a testing organization 57.

What is claimed is:

1. A multi-point temperature heating testing method used for testing if a temperature sensing component installed in the heater operating normally, comprising:
a). providing a standard temperature unit and several tested temperature units;
b). providing a testing device, and the testing device creating data after the testing device electrically connects to the standard temperature unit and the tested temperature unit;
c). the testing device performing computing on the created data after data is created;
d). saving the computed data after the computing is completed;
e). putting the standard temperature unit and the tested temperature unit in the heater;
f). the heater starting heating after putting the standard temperature unit and the tested temperature unit in the heater;
g). transferring an actual temperature measured by the standard temperature unit and a testing temperature measured by the tested temperature unit to the testing device during heating process, the testing device performing an error percentage analysis on the actual temperature and the testing temperature, if the error percentage data is within a tolerance range, the determination result being qualified, if the error percentage is not within the tolerance range, the determination result being not qualified, and determining if the sensing component installed in the heater operates normal according to the analysis data.

2. The multi-point temperature heating testing method of claim 1, wherein in step a, when arrange the standard temperature unit and the tested temperature unit, the standard temperature unit is arranged in the center, and the tested temperature unit is arranged around the standard temperature unit, the tested temperature unit is arranged at a specific distance from the standard temperature unit, the specific distance is 5 cm.

3. The multi-point temperature heating testing method of claim 2, wherein in step b, when the testing device creates data, the testing device displays a created data screen, and the created data has fields comprising a client name field, a project field, a file name field, a number selection field, a data input field, a type field, a temperature setting field, a tolerance error percentage field, a current actual value (room temperature) field, a current testing value field, a current error percentage value field, a connection button, a save button, a single entry setup button, a total setup button, a field selection button and a confirm update button; the above-mentioned data input field further comprises a number field, a brand field and a serial number field.

4. The multi-point temperature heating testing method of claim 3, wherein when presses the single entry setup button after creates the data, a number, a brand, a serial number are displayed on a single field row, and an actual temperature, a testing temperature, an error percentage and a determination result are displayed on a single field row during testing.

5. The multi-point temperature heating testing method of claim 4, wherein, when presses the setup button after creates the data, a number, a brand, a serial number are displayed on a single field row, and an actual temperature, a testing temperature, an error percentage and a determination result are displayed on a single field row during testing.

6. The multi-point temperature heating testing method of claim 5, wherein the method comprises a step h after step g, the testing device recording the data after determination analysis, and displaying a status qualified or not qualified on the displays of the testing device.

7. The multi-point temperature heating testing method of claim 6, wherein the method comprises a step i after step h, generating a calibration curve based on the recorded data and displaying the calibration curve.

8. The multi-point temperature heating testing method of claim 7, wherein the method comprises a step j after step i, transferring the recorded analysis data and the calibration curve to a printer to print out the recorded analysis data and the calibration curve for generating a report.

9. The multi-point temperature heating testing method of claim 8, wherein the method comprises a step k after step j, performing a self-test on the standard temperature unit and the tested temperature unit, when temperature data measured by the standard temperature unit and temperature data measured by the tested temperature unit are not within a setup range, the standard temperature unit are failed or damaged.

10. The multi-point temperature heating testing method of claim 9, wherein the testing device in step b comprising:
a computation unit, electrically connected to the standard temperature unit and the tested temperature unit, used for performing computing on the created data and the actual temperature and the testing temperature measured by the standard temperature unit and the tested temperature unit, analyzing error percentage values of the actual temperature and the testing temperature, determining if the temperature component is qualified or not qualified according to the error percentage value, recording the data, and generating calibration curve according to the recorded data;
an operating interface, composed of a plurality of buttons, and electrically connected to the computation unit, used for inputting data of the tested temperature unit with a plurality of buttons, and transferring the data of the tested temperature unit to the computation unit for performing computing;
a storage unit, electrically connected to the computation unit, used for saving recorded analysis data generated by performing computing of the computation unit;
a display, electrically connected to the computation unit for displaying a created data screen, data calibration table and a calibration curve generated; and
an output interface, electrically connected to the computation unit, used for electrically connecting to external printers and transferring the recorded analysis data of being qualified or not qualified and the calibration curve generated by the computation unit to a printer to print out the recorded analysis data and the calibration curve for generating a report.
